(19) United States
(12) Patent Application Publication
(10) Pub. No.: US 2025/0168894 A1
(43) Pub. Date: May 22, 2025

(54) METHODS AND APPARATUSES FOR PRACH REPETITION

(71) Applicant: LENOVO (BEIJING) LIMITED, Beijing (CN)

(72) Inventors: Yuantao Zhang, Beijing (CN); Hongmei Liu, Beijing (CN); Zhi Yan, Beijing (CN); Ruixiang Ma, Beijing (CN); Haiming Wang, Beijing (CN)

(21) Appl. No.: 18/841,107

(22) PCT Filed: Apr. 22, 2022
(86) PCT No.: PCT/CN2022/088541

§ 371 Date: Aug. 23, 2024

(51) Int. Cl. H04W 74/0833

(52) U.S. Cl. CPC H04W 74/0833

(57) ABSTRACT

Embodiments of the present disclosure relate to methods and apparatuses for physical random access channel (PRACH) repetition. According to an embodiment of the present disclosure, a user equipment (UE) can include: a processor configured to: obtain configuration information indicating a set of physical random access channel (PRACH) repetition numbers; select a PRACH repetition number from the set of PRACH repetition numbers; and determine at least one time period for PRACH repetition based on the selected PRACH repetition number, wherein each time period of the at least one time period includes a set of random access channel (RACH) occasions (ROs) for PRACH repetition; a transmitter coupled to the processor; and a receiver coupled to the processor.

### TECHNICAL FIELD

Embodiments of the present application generally relate to wireless communication technology, especially to methods and apparatuses for physical random access channel (PRACH) repetition.

### BACKGROUND

In new radio (NR) system, a random access procedure may be utilized for various purposes. For example, it may be utilized by a user equipment (UE) in initial access to find a cell to camp on; or it may be utilized by a UE which is in a radio resource control (RRC)_IDLE state or RRC_INACTIVE state to switch to an RRC_CONNECTED state to start data transmission or reception; or it may be utilized by a UE in an RRC_CONNECTED state to re-establish the lost uplink (UL) synchronization, etc.

The UE may start a random access procedure by transmitting a preamble in a PRACH. In some cases, the PRACH may be a bottlenecked channel which has the worst coverage performance. Given this, how to improve the coverage of the PRACH needs to be addressed.

### SUMMARY OF THE APPLICATION

Embodiments of the present application at least provide technical solutions for PRACH repetition.

According to some embodiments of the present application, a UE may include: a processor configured to: obtain configuration information indicating a set of physical random access channel (PRACH) repetition numbers; select a PRACH repetition number from the set of PRACH repetition numbers; determine at least one time period for PRACH repetition based on the selected PRACH repetition number, wherein each time period of the at least one time period includes a set of random access channel (RACH) occasions (ROs) for PRACH repetition; a transmitter coupled to the processor; and a receiver coupled to the processor.

In some embodiments of the present application, the processor is further configured to: determine a set of candidate ROs that are associated with a same synchronization signal and physical broadcast channel (PBCH) block (SSB) for each time period; wherein the set of ROs for PRACH repetition in each time period is the same as the set of candidate ROs, or is a subset of the set of candidate ROs.

In some embodiments of the present application, the set of ROs for PRACH repetition are not frequency domain multiplexed (FDMed) in a same time occasion.

In some embodiments of the present application, each time period is a SSB to RO association period.

In some embodiments of the present application, the processor is further configured to index FDMed RO(s) associated with the same SSB in each time period according to a pre-defined order, wherein the set of candidate ROs includes RO(s) with a same index in each time period.

In some embodiments of the present application, the indexing of FDMed RO(s) starts from low to high in frequency.

In some embodiments of the present application, the receiver is further configured to receive at least one of: first configuration information indicating a set of available SSBs; second configuration information indicating a subset of the set of available SSBs, wherein the same SSB is determined from the set of available SSBs or the subset.

In some embodiments of the present application, the processor is further configured to determine a number of the at least one time period to be ceil(K/N), wherein K is the selected PRACH repetition number and N is a number of candidate ROs in the set of candidate ROs.

In some embodiments of the present application, in the case that a total number of candidate ROs in each time period is smaller than the selected PRACH repetition number, the processor is further configured to: for each time period other than a last time period in the at least one time period, determine the set of ROs in a corresponding time period to include all candidate ROs of the set of candidate ROs in the corresponding time period; for the last time period, determine the set of ROs in the last time period to include first (K−(M−1)*N) candidate ROs in the set of candidate ROs, wherein M is the number of the at least one time period.

In some embodiments of the present application, the configuration information further indicates a number of time periods associated with each PRACH repetition number of the set of PRACH repetition numbers, and wherein the processor is further configured to determine a number of the at least one time period for the selected PRACH repetition number based on the configuration information.

In some embodiments of the present application, the processor is further configured to: for each time period other than a last time period in the at least one time period, determine the set of ROs in a corresponding time period to include first ceil(K/M) candidate ROs with a same index in the corresponding time period; for the last time period, determine the set of ROs to include first (K−(M−1)*ceil(K/M)) candidate ROs with a same index, wherein K is the selected PRACH repetition number and M is the number of the at least one time period.

In some embodiments of the present application, the set of ROs included in each time period includes a same number of ROs.

In some embodiments of the present application, for each time period of the at least one time period, the processor is further configured to determine the set of ROs in a corresponding time period to include first (K/M) candidate ROs with same index in the corresponding time period, wherein K is the selected PRACH repetition number, M is a number of the at least one time period, and K/M is a positive integer value.

In some embodiments of the present application, the processor is further configured to index time periods starting from a reference point, wherein the at least one time period is started from a time period with an index n, wherein n/M is an integer value and M is a number of the at least one time period.

In some embodiments of the present application, the processor is further configured to: divide time periods starting from a reference point into one or more groups, each group includes M consecutive time periods, wherein M is a number of the at least one time period; and index the one or more groups, wherein at least one time period is in a group of the one or more groups.

In some embodiments of the present application, in the case that the at least one time period for PRACH repetition only includes one time period for PRACH repetition, the processor is further configured to determine the set of ROs in the one time period to include first K candidate ROs with a same index in the one time period, wherein K is the selected PRACH repetition number.

In some embodiments of the present application, in the case that the at least one time period for PRACH repetition only includes one time period for PRACH repetition, the processor is further configured to: divide first K*floor(N/K) candidate ROs with a same index in the one time period into floor(N/K) groups of candidate ROs; determine the set of ROs in the one time period to include one group of candidate ROs within the floor(N/K) groups of candidate ROs, wherein K is the selected PRACH repetition number and N is a number of candidate ROs with a same index in the one time period.

According to some other embodiments of the present application, a base station (BS) may include: a transmitter configured to transmit configuration information indicating a set of PRACH repetition numbers; or a processor coupled to the transmitter and configured to obtain the configuration information; wherein the processor is further configured to: for each PRACH repetition number in the set of PRACH repetition numbers, determine at least one time period for PRACH repetition based on a corresponding PRACH repetition number, wherein each time period of the at least one time period includes a set of ROs for PRACH repetition; and a receiver coupled to the processor.

In some embodiments of the present application, the processor is further configured to: for each PRACH repetition number in the set of PRACH repetition numbers, determine a set of candidate ROs that are associated with a same SSB within each time period; wherein the set of ROs for PRACH repetition in each time period is the same as the set of candidate ROs, or is a subset of the set of candidate ROs.

In some embodiments of the present application, the set of ROs for PRACH repetition are not FDMed in a same time occasion.

In some embodiments of the present application, each time period is a SSB to RO association period.

In some embodiments of the present application, the processor is further configured to index FDMed RO(s) associated with the same SSB in each time period according to a pre-defined order, wherein the set of candidate ROs includes RO(s) with a same index in each time period.

In some embodiments of the present application, the indexing of FDMed RO(s) starts from low to high in frequency.

In some embodiments of the present application, the transmitter is further configured to transmit at least one of: first configuration information indicating a set of available SSBs; second configuration information indicating a subset of the set of available SSBs, wherein the same SSB is an SSB from the set of available SSBs or from the subset.

In some embodiments of the present application, the processor is further configured to determine a number of the at least one time period to be ceil(K/N), wherein K is the corresponding PRACH repetition number and N is a number of candidate ROs in the set of candidate ROs.

In some embodiments of the present application, in the case that a total number of candidate ROs in each time period is smaller than the corresponding PRACH repetition number, the processor is further configured to: for each time period other than a last time period in the at least one time period, determine the set of ROs in a corresponding time period to include all candidate ROs of the set of candidate ROs in the corresponding time period; for the last time period, determine the set of ROs in the last time period to include first (K−(M−1)*N) candidate ROs in the set of candidate ROs, wherein M is the number of the at least one time period.

In some embodiments of the present application, the configuration information further indicates a number of time periods associated with each PRACH repetition numbers of the set of PRACH repetition numbers.

In some embodiments of the present application, the processor is further configured to: for each time period other than a last time period in the at least one time period, determine the set of ROs in a corresponding time period to include first ceil(K/M) candidate ROs with a same index in the corresponding time period; for the last time period, determine the set of ROs to include first (K−(M−1)*ceil(K/M)) candidate ROs with a same index, wherein K is the corresponding PRACH repetition number and M is a number of the at least one time period.

In some embodiments of the present application, the set of ROs included in each time period includes a same number of ROs.

In some embodiments of the present application, for each time period of the at least one time period, the processor is further configured to determine the set of ROs in a corresponding time period to include first (K/M) candidate ROs with same index in the corresponding time period, wherein K is the corresponding PRACH repetition number, M is a number of the at least one time period, and K/M is a positive integer value.

In some embodiments of the present application, the processor is further configured to index a time periods starting from a reference point, wherein the at least one time period is started from a time period with an index n, wherein n/M is an integer value and M is a number of the at least one time period.

In some embodiments of the present application, the processor is further configured to: divide time periods starting from a reference point into one or more groups, each group includes M consecutive time periods, wherein M is a number of the at least one time period; and index the one or more groups, wherein at least one time period is in a group of the one or more groups.

In some embodiments of the present application, in the case that the at least one time period for PRACH repetition only includes one time period for PRACH repetition, the processor is further configured to determine the set of ROs in the one time period to include first K candidate ROs with a same index in the one time period, wherein K is the corresponding PRACH repetition number.

In some embodiments of the present application, in the case that the at least one time period for PRACH repetition only includes one time period for PRACH repetition, the processor is further configured to: divide first K*floor(N/K) candidate ROs with a same index in the one time period into floor(N/K) groups of candidate ROs; determine the set of ROs in the one time period to include one group of candidate ROs within the floor(N/K) groups of candidate ROs, wherein K is the corresponding PRACH repetition number and N is a number of candidate ROs with a same index in the one time period.

According to some embodiments of the present application, a method performed by a UE may include: obtaining configuration information indicating a set of PRACH repetition numbers; selecting a PRACH repetition number from the set of PRACH repetition numbers; and determining at least one time period for PRACH repetition based on the selected PRACH repetition number, wherein each time period of the at least one time period includes a set of ROs for PRACH repetition.

According to some other embodiments of the present application, a method performed by a BS may include: obtaining or transmitting configuration information indicating a set of PRACH repetition numbers; for each PRACH repetition number in the set of PRACH repetition numbers, determining at least one time period for PRACH repetition based on a corresponding PRACH repetition number, wherein each time period of the at least one time period includes a set of ROs for PRACH repetition.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary random access procedure according to some embodiments of the present application;

FIG. 3 illustrates an exemplary RACH resource structure within a PRACH configuration period according to some embodiments of the present application;

FIG. 4A-4C illustrate three exemplary associations between RO and SSB according to some embodiments of the present application;

FIG. 5 is a flow chart illustrating an exemplary method for PRACH repetition according to some embodiments of the present application;

FIG. 6 illustrates an exemplary RO indexing for each time period according to some embodiments of the present application;

FIG. 7 illustrates an exemplary RO indexing for each time period according to some other embodiments of the present application;

FIG. 8 illustrates an exemplary RO indexing for each time period according to some other embodiments of the present application;

FIG. 9 illustrates an exemplary method for determining time periods for PRACH repetition according to some other embodiments of the present application;

FIG. 10 illustrates an exemplary method for determining time periods for PRACH repetition according to some other embodiments of the present application;

FIG. 11 illustrates an exemplary method for determining a set of ROs within each time period for PRACH repetition according to some other embodiments of the present application;

FIG. 12 illustrates an exemplary method for determining a set of ROs within each time period for PRACH repetition according to some other embodiments of the present application;

FIG. 13 is a flow chart illustrating another exemplary method for PRACH repetition according to some embodiments of the present application; and

FIG. 14 illustrates a simplified block diagram of an exemplary apparatus for PRACH repetition according to some embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G (i.e., NR), 3GPP long term evolution (LTE) Release 8 and so on. Persons skilled in the art know very well that, with the development of network architecture and new service scenarios, the embodiments in the present application are also applicable to similar technical problems; and moreover, the terminologies recited in the present application may change, which should not affect the principle of the present application.

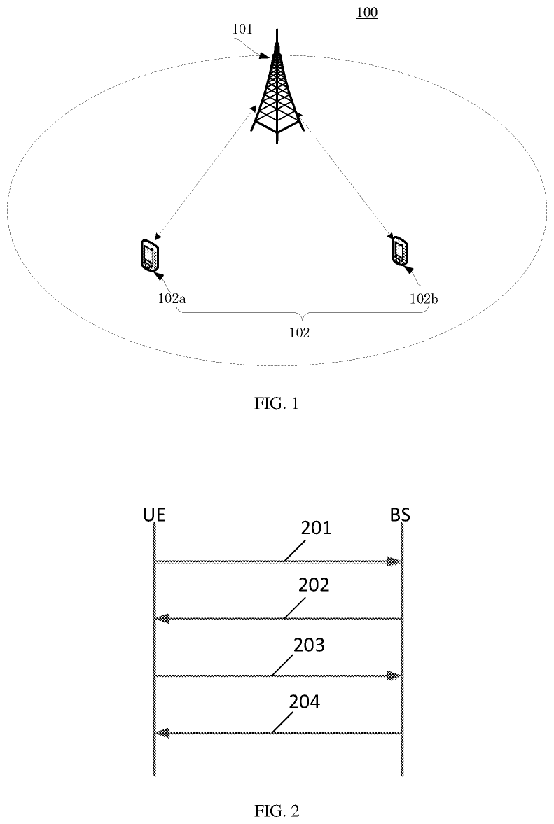

FIG. 1 is a schematic diagram illustrating an exemplary wireless communication system 100 according to some embodiments of the present application.

As shown in FIG. 1, the wireless communication system 100 includes at least one base station (BS) 101 and at least one UE 102. In particular, the wireless communication system 100 includes one BS 101 and two UEs 102 (e.g., a UE 102a and a UE 102b) for illustrative purposes. Although a specific number of BS 101 and UEs 102 are depicted in FIG. 1, it is contemplated that any number of BSs 101 and UEs 102 may be included in the wireless communication system 100.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a generalized node B (gNB), a home node-B, a relay node, or a device, or described using other terminology used in the art. The BS 101 is generally part of a radio access network that may include a controller communicably coupled to the BS 101.

According to some other embodiments of the present application, the UE(s) 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE(s) 102 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE(s) 102 may include wearable devices, such as smart watches, fitness bands, optical head-mounted displays, or the like.

Moreover, the UE(s) 102 may be referred to as a subscriber unit, a mobile, a mobile station, a user, a terminal, a mobile terminal, a wireless terminal, a fixed terminal, a subscriber station, a user terminal, or a device, or described using other terminology used in the art.

According to some embodiments of the present application, the UE(s) 102 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102a may be a power-saving UE and the UE 102b may be a VUE. In another embodiment of the present application, both the UE 102a and the UE 102b may be VUEs or power-saving UEs.

Both the UE 102a and the UE 102b in the embodiments of FIG. 1 are in a coverage area of the BS 101, and may transmit information or data to the BS 101 and receive control information or data from the BS 101, for example, via LTE or NR Uu interface. In other embodiments, one or more of the UE 102a and the UE 102b may be outside of the coverage area of the BS 101. The UE 102a and the UE 102b may communicate with each other via sidelink.

In new radio (NR) system, a random access procedure may be utilized for various purposes. For example, it may be utilized by a UE in initial access to find a cell to camp on; or it may be utilized by a UE which is in an RRC_IDLE state or RRC_INACTIVE state to switch to an RRC_CONNECTED state to start data transmission or reception; or it may be utilized by a UE in an RRC_CONNECTED state to re-establish the lost UL synchronization, etc.

FIG. 2 illustrates an exemplary random access procedure according to some embodiments of the present application. In the embodiments of FIG. 2, the random access procedure may be a 4-step RACH procedure which includes steps 201-204.

Referring to FIG. 2, in step 201, a UE may transmit Msg1 in an RO to a BS. The Msg1 may include a preamble selected by the UE.

After receiving the Msg1, in step 202, the BS may transmit DCI scheduling an RAR (e.g., Msg2) to the UE. The DCI may be identified (e.g., scrambled) by an RA-RNTI which is determined by at least one of the time position or frequency position of the RO in which the preamble is transmitted. That is, for a different RO, the corresponding RA-RNTI is different. The RAR may indicate a reception of the preamble and provide necessary information for the UE to transmit Msg3. For example, the RAR may include a timing advance (TA) command, UL grant for transmitting Msg3, etc.

Consequently, in step 202, the UE may receive the RAR from the BS. Specifically, the UE may start an RAR window after a time gap relative to the transmission of Msg1. Within the RAR window, the UE may monitor DCI for scheduling the RAR and receives the RAR.

After receiving the RAR, in step 203, the UE may transmit Msg3 to the BS. The Msg3 may include an identity of the UE. After receiving the Msg3, in step 204, the BS may transmit Msg4 to the UE. The Msg4 may include the same identity of the UE included in Msg3 to indicate the success of the random access procedure of the UE. In other words, the Msg3 and Msg4 are used to solve potential collisions due to simultaneous transmissions of the same preamble from different UEs.

According to some embodiments of the present application, the BS may configure a plurality of ROs for transmitting the preamble, and the RO in step 201 may be determined from the plurality of ROs. Each RO of the plurality of ROs may occupy multiple consecutive resource blocks (RBs). In the time domain, the ROs may be configured in every PRACH configuration period, which contains a set of radio frames. Within a PRACH configuration period, a subset of subframes may be indicated to contain a set of PRACH slots. Within each PRACH slot of the set of set of PRACH slots, there may be a set of ROs available for transmitting Msg1 as stated above. In the frequency domain, the BS may configure FDMed ROs, for example, the parameter msg1-FDM may indicate a number of FDMed ROs in the frequency domain.

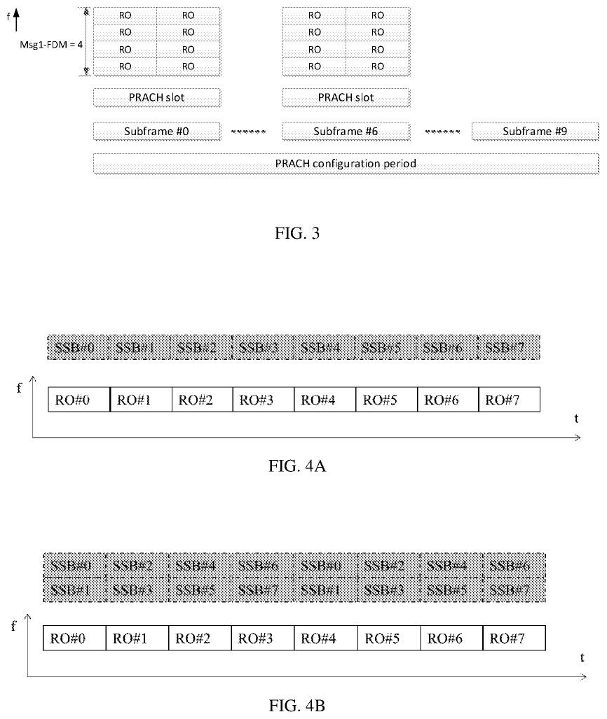

FIG. 3 illustrates an exemplary RACH resource structure within a PRACH configuration period according to some embodiments of the present application.

In the example of FIG. 3, the PRACH configuration period may include 10 subframes indexed with subframes #0 to #9, wherein subframe #0 and subframe #6 contain a PRACH slot, respectively. Moreover, it is assumed that the time duration of a PRACH slot is the same as that of a subframe. A PRACH slot is configured with 2 ROs in the time domain and 4 ROs (i.e., the parameter msg1-FDM=4) in the frequency domain.

The RACH resource structure in FIG. 3 is only for illustrative purposes, it is contemplated that a RACH resource within a PRACH configuration period may have other structures according to other parameters configured by the BS.

An RO may be associated with one or more SSBs. An SSB may be associated with a beam. An SSB may include a primary synchronization signal (PSS), a secondary synchronization signal (SSS), and PBCH, and may be used for the UE to synchronize to the downlink (DL), obtain the cell ID, acquire system information, etc.

In some embodiments of the present application, the BS may configure a plurality of SSBs for a UE, e.g., the indexes of a plurality of SSBs may be included in the system information from the BS. In such embodiments, the UE may obtain plurality of SSBs (e.g., the UE may obtain the indexes of the plurality of SSBs in the system information). Then, the UE may measure the channel status of each SSB of the plurality of SSBs, select one SSB with good channel quality, and transmit the preamble in an RO which is associated with the one SSB.

In some embodiments of the present application, the association between SSB and RO may be configured by the BS to the UE. Specifically, the BS may transmit configuration information to the UE to indicate the association between SSB and RO, for example, the BS may transmit a parameter SSB-PerRACH-Occasion to indicate the association between SSB and RO. In an embodiment, the configuration information (i.e., SSB-PerRACH-Occasion=1) may indicate that one SSB is associated with one RO (i.e., which is referred to as 1-to-1 association hereinafter). In another embodiment, the configuration information (i.e., SSB-PerRACH-Occasion=N, N>1) may indicate that more than one SSB is associated with one RO (which is referred to as N-to-1 association hereinafter). In yet another example, the configuration information (i.e., SSB-PerRACH-Occasion=1/N) may indicate that one SSB is associated with more than one RO (which is referred to as 1-to-N association hereinafter).

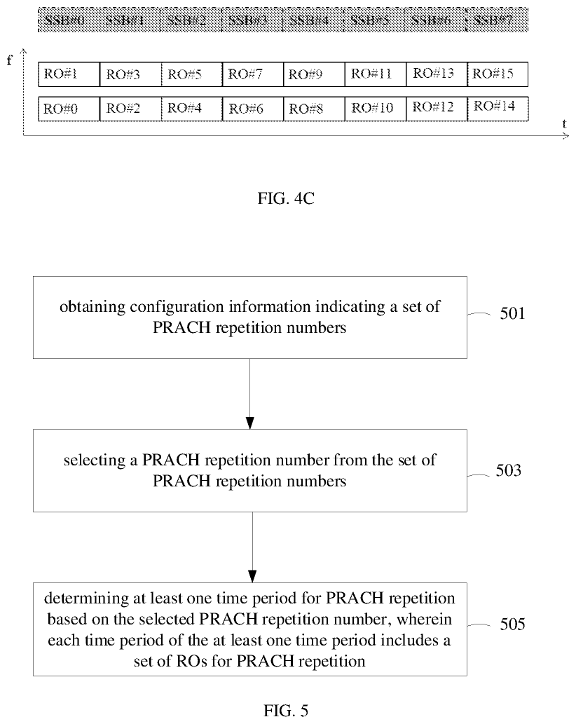

FIGS. 4A-4C illustrate three exemplary associations between RO and SSB according to some embodiments of the present application.

Referring to FIG. 4A, it shows a 1-to-1 association between SSB and RO. Specifically, it is assumed that: there are 8 SSBs indexed with SSB #0 to SSB #7; there is one RO in the frequency domain and the association period includes 8 ROs indexed with RO #0 to RO #7. Moreover, it is assumed that SSB-PerRACH-Occasion=1. Then, SSB #0 to SSB #7 may be mapped to RO #0 to RO #7, respectively.

Referring to FIG. 4B, it shows a 2-to-1 association between SSB and RO. Specifically, it is assumed that: there are 8 SSBs indexed with SSB #0 to SSB #7; there is one RO in the frequency domain and the association period includes 8 ROs indexed with RO #0 to RO #7. Moreover, it is assumed that SSB-PerRACH-Occasion=2. Then, SSB #0 and SSB #1 may be associated with RO #0, SSB #2 and SSB #3 may be associated with RO #1, SSB #4 and SSB #5 may be associated with RO #2, SSB #6 and SSB #7 may be associated with RO #3, SSB #0 and SSB #1 may be associated with RO #4, SSB #2 and SSB #3 may be associated with RO #5, SSB #4 and SSB #5 may be associated with RO #6, SSB #6 and SSB #7 may be associated with RO #7.

Referring to FIG. 4C, it shows a 1-to-2 association between SSB and RO. Specifically, it is assumed that: there are 8 SSBs indexed with SSB #0 to SSB #7; there are two ROs in the frequency domain and the association period includes 16 ROs indexed with RO #0 to RO #15. Moreover, it is assumed that SSB-PerRACH-Occasion=1/2. Then, SSB #0 may be associated with RO #0 and RO #1, SSB #1 may be associated with RO #2 and RO #3, SSB #2 may be associated with RO #4 and RO #5, SSB #3 may be associated with RO #6 and RO #7, SSB #4 may be associated with RO #8 and RO #9, SSB #5 may be associated with RO #10 and RO #11, SSB #6 may be associated with RO #12 and RO #13, SSB #7 may be associated with RO #14 and RO #15.

In some embodiments of the present application, the association between SSB and RO may be performed periodically in each SSB to RO association period. The association period is X (e.g., X is an integer larger than 0) times of the PRACH configuration period, and contains one or more SSB to RO mapping cycles. In an embodiment of the present application, the duration of SSB to RO association period is the minimum period such that within the SSB to RO association period, each SSB is associated with at least one RO.

NR supports preamble transmission without repetition. However, in some cases, the PRACH may be a bottlenecked channel which has the worst coverage performance, e.g., if short PRACH format (e.g., PRACH format B4 as specified in TS 38.211) is used. Given this, how to improve the coverage of the PRACH needs to be addressed.

According to some embodiments of the present application, the PRACH coverage enhancement may be obtained by PRACH repetitions with a same beam. Specifically, the PRACH repetitions may refer to repeated PRACH preamble transmissions or transmitting the preamble in more than one ROs, wherein each preamble transmission or transmitting the preamble in an RO may be referred to as a PRACH repetition. A PRACH repetition may also be referred to as a preamble repetition. PRACH repetitions with a same beam means that the more than one ROs are associated with a same SSB.

In order to achieve the PRACH repetitions with a same beam, one issue that needs to be solved is how to determine the ROs for repetition. When determining the ROs for repetition, the following factors need to be considered.

On the one hand, due to the flexible SSB to RO association and the flexible RO configuration in at least one of time domain or frequency domain, one SSB may be associated with only one RO of the FDMed ROs, or may be associated with two or more FDMed ROs. It is not desired to repeatedly transmit a RACH preamble in the two or more FDMed ROs, because there will be almost no performance improvement with only fractional transmission power being used for each transmission.

On the other hand, it is desirable to design a common solution applicable for the flexible SSB to RO association and for the case with FDMed ROs or without FDMed ROs.

Besides, the BS and UE need to have the common understanding on the ROs for repetition, otherwise the preamble cannot be correctly received by the BS.

Given the above, embodiments of the present application propose solutions for PRACH repetition with a same beam, which takes flexible SSB to RO association and flexible RO configuration into consideration. For example, embodiments of the present application propose solutions regarding how to determine at least one time periods for PRACH repetition and how to determine a set of ROs for PRACH repetition within each time period. More details on embodiments of the present application will be illustrated in the following text in combination with the appended drawings.

FIG. 5 is a flow chart illustrating an exemplary method for PRACH repetition according to some embodiments of the present application. The method in FIG. 5 may be implemented by a UE (e.g., UE 102a or UE 102b as shown in FIG. 1).

In the exemplary method shown in FIG. 5, in step 501, the UE may obtain configuration information, the configuration information may indicate a set of PRACH repetition numbers. The set of PRACH repetition numbers may include one or more PRACH repetition numbers.

In some embodiments of the present application, obtaining the configuration information may refer to receiving the configuration information from a BS (e.g., BS 101 as shown in FIG. 1). For example, the configuration information is received from the BS via a signaling, e.g., a system information block (SIB), a master information block (MIB), a radio resource control (RRC) signaling, a medium access control (MAC) layer control element (CE), or downlink control information (DCI).

In some other embodiments of the present application, the configuration information may be pre-configured or pre-defined to the UE. Specifically, the configuration information pre-configured or pre-defined to the UE may refer to that: the configuration information may be hard-wired into the UE or stored on a memory, a subscriber identity module (SIM), or an universal subscriber identity module (USIM) card for the UE. In such embodiments, obtaining the configuration may refer to obtaining (or receiving) the configuration information within the UE.

In some embodiments of the present application, the UE may receive a first configuration information indicating a set of available SSBs from the BS, and thus PRACH repetition may be performed using the beams of these SSBs. In some other embodiments, the UE may further receive a second configuration information indicating a subset of the set of available SSBs, and thus PRACH repetition may be performed using the beams of this subset of SSBs. The first configuration information and the second configuration information may be received via broadcast system information from the BS, or received via a UE dedicated signaling from the BS, such as an RRC signaling, or a MAC signaling, or a DCI. In some embodiments, the set of PRACH repetition numbers are common for all the indicated SSBs (the indicated SSBs may be the SSBs in the set of available SSBs or the SSBs in the subset of SSBs), or the PRACH repetition number may be configured per SSB. That is, each PRACH repetition number in the configuration information may be associated with an SSB of the indicated SSBs.

After receiving the set of PRACH repetition numbers, in step 503, the UE may select a PRACH repetition number from the set of PRACH repetition numbers.

In some embodiments, the UE may measure the channel status of each SSB of the indicated SSBs, select one SSB with best channel quality from the indicated SSBs, and transmit the preamble in RO(s) which is associated with the one SSB.

In some embodiments, in the case that each PRACH repetition number in the configuration information is associated with an SSB of the indicated SSBs, in step 503, the UE may select a PRACH repetition number which is associated with the one SSB.

In some embodiments, the UE may select a PRACH repetition number from the set of PRACH repetition numbers based on the measured channel status of the one SSB, for example, in the case that the measured channel status is lower than a certain threshold, the UE may select a larger PRACH repetition number; in the case that the measured channel status is larger than another threshold, the UE may select a smaller PRACH repetition number.

After selecting the PRACH repetition number, in step 505, the UE may determine at least one time period for PRACH repetition based on the selected PRACH repetition number. Each time period of the at least one time period may include a set of ROs for PRACH repetition.

In some embodiments of the present application, determining the at least one time period for PRACH repetitions may include determining a number of the at least one time period for PRACH repetitions and determining a position of the at least one time period for PRACH repetitions.

In some embodiments of the present application, each time period of the at least one time period may be an SSB to RO association period. In some other embodiments of the present application, each time period of the at least one time period may be any other time period, such as an SSB to RO mapping cycle, or an SSB to RO association pattern period that contains at least one SSB to RO association period.

According to some embodiments of the present application, the number of the at least one time period may be determined based on a set of candidate ROs for each time period of the at least one time periods. In such embodiments, the UE may determine a set of candidate ROs for each time period. The set of ROs for PRACH repetition in each time period may be the same as the set of candidate ROs, or is a subset of the set of candidate ROs.

The set of candidate ROs for each time period may be determined by taking the following two factors into consideration.

First, in the embodiments of the present application, the UE may transmit PRACH preamble using a same beam in each repetition. Given this, the set of candidate ROs for each time period may be associated with a same SSB.

In some embodiments of the present application, the same SSB may be determined from the indicated SSBs for PRACH repetition as stated above. For example, the UE may measure the channel status of each SSB of the indicated SSBs, select one SSB with best channel quality from the indicated SSBs as the same SSB. Second, besides the requirement of mapping to a same SSB, the set of ROs for PRACH repetition in each time period are not FDMed in a same time occasion, i.e., the repetitions may not be performed in FDMed ROs, otherwise there will be little or even no performance improvement on PRACH detection. Given this, the set of candidate ROs should not FDMed in a same time occasion. In order to determine such kind of candidate ROs, one simple and clear design to is to enable the set of candidate ROs for PRACH repetition to have a same relative position in the FDMed ROs, if the FDMed ROs are configured.

In order to achieve “same relative position in the FDMed ROs,” the UE may index FDMed RO(s) associated with the same SSB in each time period according to a pre-defined order. In some embodiments, the pre-defined order may refer to indexing of FDMed RO(s) starts from low to high in frequency. However, the pre-defined order may be any other order in some other embodiments of the present application.

The FDMed RO(s) associated with the same SSB in each time period may include one or more sets of FDMed RO(s) associated with the same SSB, wherein each set of FDMed RO(s) may refer to FDMed RO(s) associated with the same SSB in a same time occasion. In such cases, indexing FDMed RO(s) associated with the same SSB in each time period may refer to indexing each set of FDMed RO(s) associated with the same SSB.

Consequently, the set of candidate ROs for each time period may include RO(s) with a same index in each time period. In such embodiments, the ROs with same index are those having same relative position in the FDMed ROs.

According to some embodiments of the present application, the indexing of FDMed RO(s) may be determined by parameters SSB-perRACH-Occasion and Msg1-FDM as stated above.

In some embodiments, SSB-perRACH-Occasion<1, which means that one SSB is mapped to (or associated with) more than one ROs.

In such embodiments, if 1/SSB-perRACH-Occaison<msg1-FDM, which means that the number of FDMed ROs mapped to (or associated with) a same SSB out of a set of FDMed ROs is larger than 1 but less than the number of FDMed ROs, then the number of FDMed ROs for indexing is 1/SSB-perRACH-Occasion. Accordingly, the FDMed ROs are indexed as [0, 1, . . . , 1/SSB-perRACH-Occasion-1], from an RO with the lowest position in the frequency domain to an RO with the highest position in the frequency domain.

In such embodiments, if 1/SSB-perRACH-Occasion>=msg1-FDM, which means that the number of FDMed ROs mapped to (or associated with) a same SSB out of the FDMed ROs is larger or equal to the number of FDMed ROs, then the number of FDMed ROs for indexing is msg1-FDM. Accordingly, the FDMed ROs are indexed as [0, 1, . . . , msg1-FDM-1], from an RO with the lowest position in the frequency domain to an RO with the highest position in the frequency domain.

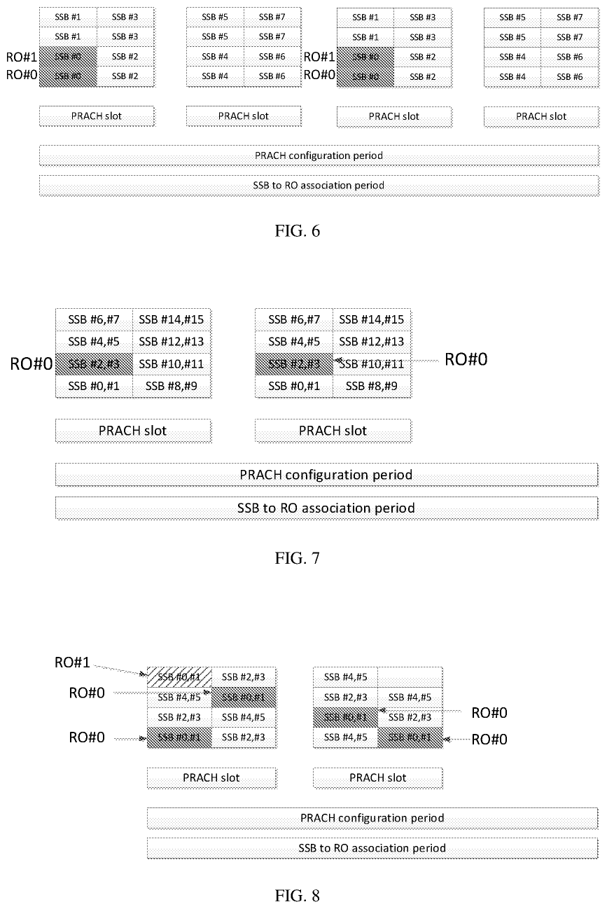

FIG. 6 illustrates an exemplary RO indexing for each time period according to some embodiments of the present application. In the example of FIG. 6, SSB-perRACH-Occasion<1 and 1/SSB-perRACH-Occaison<msg1-FDM.

Referring to FIG. 6, it is assumed that:
1) Each time period for PRACH repetition is an SSB to RO association period, wherein a time duration of the SSB to RO association period is equal to that of a PRACH configuration period which includes four PRACH slots;
2) The configured SSBs for PRACH repetition is {0,1,2,3,4,5,6,7};
3) SSB-PerRACH-Occasion=½, meaning that 2 consecutive ROs in the frequency domain are mapped to a same SSB;
4) Msg1-FDM=4, meaning that there are 4 FDMed ROs in the frequency domain.

Based on the above configurations, the whole PRACH resource and the SSB to RO association within each time period may be illustrated in FIG. 6, for example, the 4 FDMed ROs in the left most column are associated with SSB #0 and SSB #1, respectively. The UE may measure all the SSBs {10,1,2,3,4,5,6,7} and determine that SSB #0 is the SSB with the best channel quality, then the UE may determine the PRACH repetition to be performed in ROs associated with SSB #0.

Then, the UE may index the FDMed ROs mapped with the same determined SSB, i.e., SSB #0. As shown in FIG. 6, two FDMed ROs associated with SSB #0 out of a set of FDMed ROs are indexed as RO #0 and RO #1. Then, the set of candidate ROs for each time period may include the two ROs with a same index, e.g., ROs with index #0 or ROs with index #1, as shown in the figure.

In some other embodiments, SSB-perRACH-Occasion>=1, which means that one or more SSBs are mapped to (or associated with) a same RO.

In an embodiment, if only one RO in a set of FDMed ROs (e.g., the FDMed ROs in a same time occasion) is associated with a same SSB (i.e., the number of ROs for indexing is 1), then the one RO may be included in the set of candidate ROs.

In another embodiment, if there is more than one FDMed RO in the set of FDMed ROs that are associated with a same SSB, only one RO, e.g., RO in the lowest (or highest) frequency position may be included in the set of candidate ROs.

In yet another embodiment, there may be more than one FDMed RO associated with a same SSB in each time period, then the UE may determine one or more sets of candidate ROs, each set may be associated with a different index. In such embodiment, only the set of candidate ROs which has a largest number of candidate ROs can be used for PRACH repetition.

FIG. 7 illustrates an exemplary RO indexing for each time period according to some other embodiments of the present application. In the example of FIG. 7, SSB-perRACH-Occasion>1.

Referring to FIG. 7, it is assumed that:
1) Each time period for PRACH repetition is an SSB to RO association period, wherein a time duration of the SSB to RO association period is equal to that of a PRACH configuration period which includes two PRACH slots;
2) The configured SSBs for PRACH repetition is {0, 1, 2, 3, . . . , 15}; 3) SSB-PerRACH-Occasion=2, meaning that 2 SSBs are mapped to a same RO; and
4) Msg1-FDM=4, meaning that there are 4 FDMed ROs in the frequency domain.

Based on the above configurations, the whole RACH resource and the SSB to RO association within each time period may be illustrated in FIG. 7, for example, the 4 FDMed ROs in the left most column are associated with SSB #0 and SSB #1, SSB #2 and SSB #3, SSB #4 and SSB #5, and SSB #6 and SSB #7, respectively. The UE may measure all the SSBs {0, 1, 2, 3, . . . , 15} and determine that SSB #2 is the SSB with the best channel quality, then the UE may determine that the PRACH repetition to be performed in ROs associated with SSB #1.

As shown in FIG. 7, only one RO out of a set of FDMed ROs is associated with SSB #2, and may be indexed with RO #0. Then, the set of candidate ROs for each time period may include the two ROs with a same index, e.g., ROs with index #0.

FIG. 8 illustrates an exemplary RO indexing for each time period according to some other embodiments of the present application. In the example of FIG. 8, SSB-perRACH-Occasion>1.

Referring to FIG. 8, it is assumed that:
1) Each time period for PRACH repetition is an SSB to RO association period, wherein a time duration of the SSB to RO association period is equal to that of a PRACH configuration period which includes two PRACH slots;
2) The configured SSBs for PRACH repetition is {0,1,2,3,4,5};
3) SSB-PerRACH-Occasion=2, meaning that 2 SSBs are mapped to a same RO; 4) Msg1-FDM=4, meaning that there are 4 FDMed ROs in the frequency domain.
Based on the above configurations, the whole RACH resource and the SSB to RO association within each time period may be illustrated in FIG. 7. The UE may measure all the SSBs {0, 1, 2, 3, . . . , 15} and determine that SSB #1 is the SSB with the best channel quality, then the UE may determine that the PRACH repetition to be performed in ROs associated with SSB #1.

As shown in FIG. 8, in a first set of FDMed ROs (i.e., the left most column), 2 FDMed ROs are associated with SSB #1 and may be indexed as RO #0 and RO #1, while in the remaining sets of FDMed ROs, only one RO out of the FDMed ROs is associated with SSB #1 and may be indexed as RO #0.

In an embodiment, the RO in the lowest frequency position of the FDM ROs associated with a same SSB may be included in the set of candidate ROs. Then, the set of candidate ROs for each time period may include the four ROs with a same index, e.g., ROs with index #0.

In another embodiment, the UE may determine two sets of candidate ROs, wherein one set includes four ROs with index #0 and the other set includes one RO with index #1, since only the set of candidate ROs which has a largest number of ROs can be used for PRACH repetition, then, for each time period, the UE may determine that the set including four ROs with index #0 is the set of candidate ROs used for PRACH repetition. In the example of FIG. 8, RO #1 is not used for PRACH repetition.

As stated above, in some embodiments of the present application, the number of time periods for PRACH repetition may be determined based on the selected PRACH repetition number and the set of candidate ROs for each time period. In such embodiments, the UE may determine the number of the at least one time period for PRACH repetition to be ceil(K/N), wherein K is the selected PRACH repetition number and N is a number of candidate ROs in the set of candidate ROs.

Then, the UE may determine the position of the at least one time period.

According to some embodiments of the present application, the UE may index time periods. The indexing may start from a reference point (e.g., a system frame with a system frame number (SFN)=0). In such embodiments, the at least one time period for PRACH repetition may start from a time period with an index n of the indexed time periods, and includes M consecutive time periods (including the starting time period), wherein n/M is an integer value and M is a number of the more than one time period.

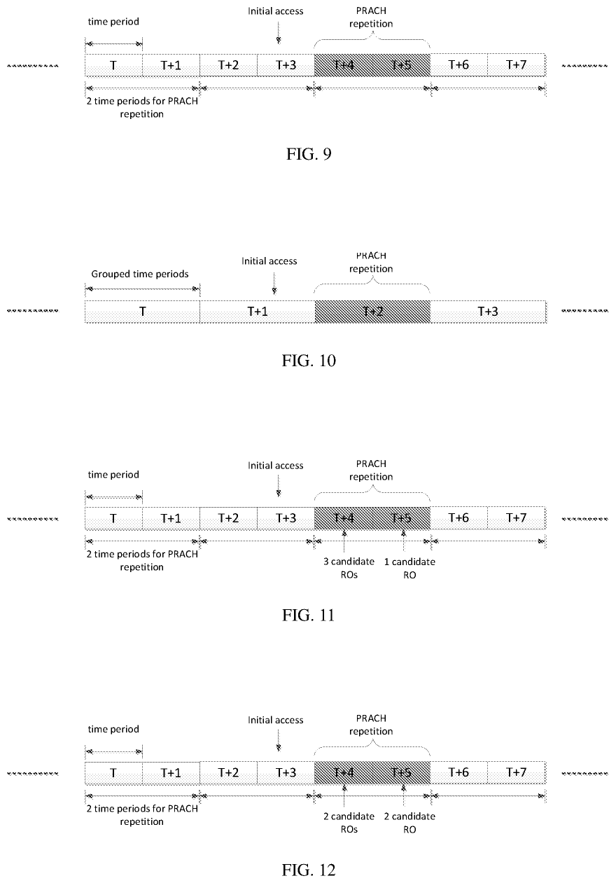

FIG. 9 illustrates an exemplary method for determining time periods for PRACH repetition according to some other embodiments of the present application. Referring to FIG. 9, the time periods are indexed. The at least one period for PRACH repetition may be started from a first time period which is after a time period in which the UE decides to perform initial access, and with an index n satisfying n/M is an integer value. For example, when the UE decides to start an initial access within a time period #T+3 or within a time #T+2 (wherein T is a non-negative integer, and is an even value), the at least one time period for PRACH repetition may include time periods #T+4 and #T+5 in the case that M=2.

According to some other embodiments of the present application, the UE may divide one or more time periods into one or more groups. The one or more timing periods may start from a reference point (e.g., a system frame with a system frame number (SFN)=0). In such embodiments, each group may include M consecutive time periods, wherein M is a number of the at least one time period. Then, the UE may index the one or more groups. The at least one time period may be in a group of the one or more groups.

FIG. 10 illustrates an exemplary method for determining time periods for PRACH repetition according to some other embodiments of the present application. Referring to FIG. 10, the plurality of time periods are divided into one or more groups, these groups are indexed. The at least one period for PRACH repetition may be in a first group of time periods after a group of time periods in which the UE decides to start initial access. For example, when the UE starts an initial access within a group of time periods #T+1, the at least one time period for PRACH repetition is the group of periods #T+2.

After determining the number of the at least one time period for PRACH repetition, the UE may determine the set of ROs which are actually used for PRACH repetition in each time period of the at least one time period. Specifically, as stated above, for each time period of the at least one time period, the set of ROs in a corresponding time period may be the same as the set of candidate ROs in a corresponding time period or may be a subset of the set of candidate ROs in a corresponding time period.

According to some embodiments of the present application, a total number of candidate ROs (i.e., a number of candidate ROs in a set of candidate ROs) in each time period may be smaller than the selected PRACH repetition number (i.e., N<K). In such embodiments, the number of at least one time periods (i.e., M) for PRACH repetition is larger than 1. That is, the at least one time period includes more than one time period (i.e., M>1). In such embodiments, the following methods may be used for determining the set of ROs in each time period for PRACH repetition.

In an embodiment, for each time period other than a last time period in the M time periods, the UE may determine the set of ROs in a corresponding time period to include all candidate ROs of the set of candidate ROs in the corresponding time period; for the last time period, the UE may determine the set of ROs in the last time period to include first (K−(M−1)*N) candidate ROs in the set of candidate ROs, wherein M is the number of the at least one time period.

FIG. 11 illustrates an exemplary method for determining a set of ROs within each time period for PRACH repetition according to some other embodiments of the present application.

Referring to FIG. 11, it is assumed that the set of candidate ROs determined based on the above methods include 3 candidate ROs for each time period, and the selected PRACH repetition number is 4. Then, the number of time periods is ceil (4/3)=2 (i.e., M=2). Moreover, it is assumed that the UE may start the initial access within the time period #T+3, then, the time periods for PRACH repetition are time periods #T+4 and #T+5. Based on the above method, for time period #T+4, the set of ROs for PRACH repetition includes all the candidate ROs (i.e., 3 candidate ROs). For the time period #T+5, the set of ROs for PRACH repetition includes the first (4−(2−1)*3) candidate RO in the set of candidate ROs. That is, the set of ROs for PRACH repetition in time period #T+5 includes the first one candidate RO of the 3 candidate ROs.

In another embodiment, in the case that K/M is a positive integer value, the set of ROs included in each time period may include a same number of ROs. For example, for each time period of the M time period, the UE may determine the set of ROs in a corresponding time period to include first (K/M) candidate ROs of the set of candidate ROs in the corresponding time period.

FIG. 12 illustrates an exemplary method for determining a set of ROs within each time period for PRACH repetition according to some other embodiments of the present application.

Referring to FIG. 12, it is assumed that the set of candidate ROs determined based on the above methods include 3 candidate ROs (i.e., N=3) for each time period, and the selected PRACH repetition number is 4 (i.e., K=4). Then, the number of time periods is ceil (4/3)=2 (i.e., M=2). Moreover, it is assumed that the UE may start the initial access within the time period #T+3, then, the time periods for PRACH repetition is time periods #T+4 and #T+5. In such example, K/M=2. Accordingly, based on the above method, for time period #4 or #5, the set of ROs for PRACH repetition may include first (4/2=2) candidate ROs of the 3 candidate ROs in time period #T+4 or #T+5.

According to some embodiments of the present application, a total number of candidate ROs in each time period may be larger than or equal to the selected PRACH repetition number (i.e., N>=K). In such embodiments, the number of at least one time periods (i.e., M) is 1. That is, the at least one time period only includes one time period (i.e., M=1). In such embodiments, the following methods may be used for determining the set of ROs in the time period for PRACH repetition.

In an embodiment, the UE may determine the set of ROs in the one time period to include first K candidate ROs of the set of candidate ROs in the one time period. For example, it is assumed that N=8 and K=3, then the set of ROs for PRACH repetition may include first 3 candidate ROs of the 8 candidate ROs.

In another embodiment, the UE may divide first K*floor(N/K) candidate ROs in the set of candidate ROs in the one time period into floor(N/K) groups of candidate ROs; then the UE may determine the set of ROs in the one time period to include one group of candidate ROs within the floor(N/K) groups of candidate ROs. For example, it is assumed that N=8 and K=3, then the UE may divide first (3*floor (8/3)=6) candidate ROs in the time period into 2 groups, for example, the first group may include the first three candidate ROs and the second group may include the following three candidate ROs. Then the set of ROs for PRACH repetition may include the first group of candidate ROs or the second group of candidate ROs.

In the above embodiments, the number of time periods for PRACH repetition may be determined based on the set of candidate ROs for each time period. However, according to some other embodiments of the present application, the number of time periods for PRACH repetition may not be determined based on the set of candidate ROs for each time period. In such embodiments, the configuration information in step 501 may further indicate a number of time periods associated with each PRACH repetition number of the set of PRACH repetition numbers. Consequently, after receiving the configuration information, the UE may select a PRACH repetition number in step 502. Then, the UE may determine the number of the at least one time periods for PRACH repetition to be a number of time periods indicated by the configuration information and associated with the selected PRACH repetition number.

In such embodiments, the methods for determining the position of the at least one time periods (e.g., as shown in FIGS. 9 and 10) as stated above may also be applied herein.

According to some embodiments of the present application, the number of at least one time periods (i.e., M) associated with the selected PRACH repetition number (e.g., K) may be larger than 1. That is, the at least one time period includes more than one time period (i.e., M>1). In such embodiments, the following methods may be used for determining the set of ROs in each time period for PRACH repetition.

In an embodiment, for each time period other than a last time period in the M time periods, the UE may determine the set of ROs in a corresponding time period to include first ceil(K/M) candidate ROs of a set of candidate ROs in the corresponding time period; for the last time period, the UE may determine that the set of ROs to include first (K−(M−1)*ceil(K/M)) candidate ROs of a set of candidate ROs in the last time period. In such embodiment, a set of candidate ROs in a time period may be associated with a same SSB and with a same index, and may be determined based on the methods as stated above.

For example, it is assumed that K=8 and M=3. Then, for the first or second time period, the set of ROs for PRACH repetition may include first (ceil(8/3)=3) candidate ROs in the first or second time period. For the last time period, the set of ROs for PRACH repetition may include first (8−(3−1)*ceil(8/3)) (i.e., 2) candidate ROs in the last time period.

In another embodiment, in the case that K/M is a positive integer value, the set of ROs included in each time period may include a same number of ROs. For example, for each time period of the M time period, the UE may determine the set of ROs in a corresponding time period to include first (K/M) candidate ROs of the set of candidate ROs in the corresponding time period. For example, it is assumed that K=4 and M=2, then for each time period of the two time periods, the set of ROs for PRACH repetition may include first (4/2=2) candidate ROs in a corresponding time period.

According to some other embodiments of the present application, the number of at least one time periods (i.e., M) associated with the selected PRACH repetition number (e.g., K) is one. That is, the at least one time period only includes more than one time period. In such embodiments, the above methods for determining the set of ROs in the one time period may also be applied herein.

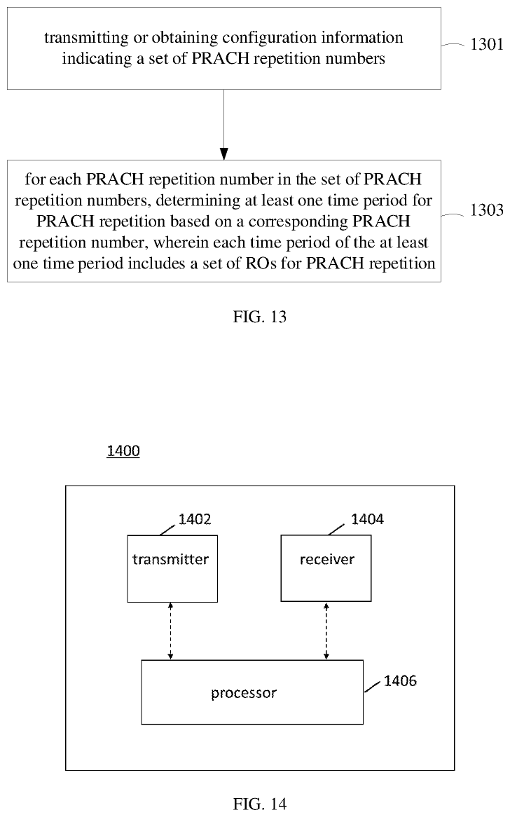

FIG. 13 is a flow chart illustrating an exemplary method for PRACH repetition according to some embodiments of the present application. The method in FIG. 13 may be implemented by a BS (e.g., BS 101 as shown in FIG. 1).

In the exemplary method shown in FIG. 13, in step 1301, in some embodiments, the BS may obtain configuration information, the configuration information may indicate a set of PRACH repetition numbers. The set of PRACH repetition numbers may include one or more PRACH repetition numbers. In such embodiments, the configuration information may be pre-configured or pre-defined to the BS. Specifically, the configuration information pre-configured or pre-defined to the BS may refer to that: the configuration information may be hard-wired into the BS or stored on a memory of the BS. In such embodiments, obtaining the configuration may refer to obtaining (or receiving) the configuration information within the BS.

In step 1301, in some other embodiments, the BS may transmit the configuration information to at least one UE (e.g., UE 102a and UE 102b as shown in FIG. 1). For example, the configuration information may be transmitted from the BS to a UE via a signaling, e.g., a system information block (SIB), a master information block (MIB), a radio resource control (RRC) signaling, a medium access control (MAC) layer control element (CE), or downlink control information (DCI).

In some embodiments of the present application, the BS may transmit a first configuration information indicating a set of available SSBs to the at least one UE, and thus these SSBs may be used for PRACH repetition for the at least one UE. In some other embodiments, the BS may further transmit a second configuration information indicating a subset of the set of available SSBs to the at least one UE, and thus the subset of SSBs may be used for PRACH repetition for the at least one UE. The first configuration information and the second configuration information may be transmitted via broadcast system information or transmitted via a UE dedicated signaling, such as an RRC signaling, or a MAC signaling, or a DCI. In some embodiments, the set of PRACH repetition numbers are common for all the indicated SSBs (the indicated SSBs may be the SSBs in the set of available SSBs or the SSBs in the subset of SSBs), or the PRACH repetition number may be configured per SSB. That is, each PRACH repetition number in the configuration information may be associated with an SSB of the indicated SSBs.

Since the BS may receive PRACH repetitions from one or more UEs of the at least one UE, and these UEs may select different PRACH repetition numbers, in step 1303, for each PRACH repetition number in the set of PRACH repetition numbers, the BS may determine at least one time period for PRACH repetition based on a corresponding PRACH repetition number. Each time period of the at least one time period may include a set of ROs for PRACH repetition.

In some embodiments of the present application, determining the at least one time period for PRACH repetitions may include determining a number of the at least one time period for PRACH repetitions and determining a position of the at least one time period for PRACH repetitions.

In some embodiments of the present application, each time period of the at least one time period may be an SSB to RO association period. In some other embodiments of the present application, each time period of the at least one time period may be any other time period, such as an SSB to RO mapping cycle, or an SSB to RO association pattern period that contains at least one SSB to RO association period.

According to some embodiments of the present application, for each PRACH repetition number in the set of PRACH repetition numbers, the number of the at least one time period may be determined based on a set of candidate ROs for each time period and the corresponding PRACH repetition number.

In such embodiments, for each PRACH repetition number in the set of PRACH repetition numbers, the BS may determine a set of candidate ROs associated with a same SSB for each time period. The set of ROs for PRACH repetition in each time period may be the same as the set of candidate ROs, or is a subset of the set of candidate ROs. The same SSB for each PRACH repetition number may be determined as follows.

In some cases, each PRACH repetition number may be associated with an SSB of the indicated SSBs. Consequently, for each PRACH repetition number, the same SSB for PRACH repetition may be an SSB associated with a corresponding PRACH repetition number.

In some other cases, the set of PRACH repetition numbers may be common for all the indicated SSBs. In such embodiments, for each PRACH repetition number, the same SSB for PRACH repetition may be any SSB in the subset of SSBs. Consequently, for each PRACH repetition number, the BS may determine at least one set of candidate ROs, wherein each set of candidate ROs of the at least one set of candidate ROs is associated with a corresponding SSB in the indicated SSBs.

For simplicity, embodiments in FIG. 13 only illustrates for each PRACH repetition number, determining a set of candidate ROs associated with an SSB in the indicated SSBs, persons skilled in the art can understand the methods regarding determining a set of candidate ROs associated with the SSB may be applied for determining a set of candidate ROs associated with other SSBs in the indicated SSBs.

In addition, besides the requirement of mapping to a same SSB, the set of ROs for PRACH repetition in each time period are not FDMed in a same time occasion. Given this, the set of candidate ROs should not FDMed in a same time occasion.

Based on the above, the BS may determine the set of candidate ROs for each time period. Specifically, the BS may use the same methods as those used by the UE in the embodiments of FIG. 5 to determine the set of candidate ROs associated with the same SSB for each time period. For example, the BS may index FDMed RO(s) associated with the same SSB in each time period according to a pre-defined order. In some embodiments, the pre-defined order may refer to indexing of FDMed RO(s) starts from low to high in frequency. However, the pre-defined order may be any other order in some other embodiments of the present application. Consequently, the set of candidate ROs for each time period may include RO(s) with a same index in each time period.

After determining the set of candidate ROs for each PRACH repetition number of the set of PRACH repetition numbers, for each PRACH repetition number of the set of PRACH repetition numbers, the BS may determine the number of the at least one time period for PRACH repetition to be ceil(K/N), wherein K is a corresponding PRACH repetition number and N is a number of candidate ROs in the set of candidate ROs for the corresponding PRACH repetition number.

Then, the BS may determine the position of the at least one time period. Specifically, the BS may use the same methods as those used by the UE in the embodiments of FIG. 5 to determine the position of the at least one time period.

According to some embodiments of the present application, the BS may index time periods. The indexing may start from a reference point (e.g., a system frame with a system frame number (SFN)=0). In such embodiments, the at least one time period for PRACH repetition may start from a time period with an index n of the indexed time periods, and includes M consecutive time periods (including the starting time period), wherein n/M is an integer value and M is a number of the more than one time period.

According to some other embodiments of the present application, the BS may divide one or more time periods into one or more groups. The one or more timing periods may start from a reference point (e.g., a system frame with a system frame number (SFN)=0). In such embodiments, each group may include M consecutive time periods, wherein M is a number of the at least one time period. Then, the UE may index the one or more groups. The at least one time period may be in a group of the one or more groups.

After determining the number of the at least one time period for PRACH repetition, the BS may determine the set of ROs which are actually used for PRACH repetition in each time period of the at least one time period.

According to some embodiments of the present application, a total number of candidate ROs (i.e., a number of candidate ROs in a set of candidate ROs) in each time period may be smaller than the corresponding PRACH repetition number (i.e., N<K). In such embodiments, the number of at least one time periods (i.e., M) for PRACH repetition is larger than 1. That is, the at least one time period includes more than one time period (i.e., M>1). In such embodiments, the BS may use the same methods as those used by the UE in the embodiments of FIG. 5 to determine the set of ROs in each time period.

In an embodiment, for each time period other than a last time period in the M time periods, the BS may determine the set of ROs in a corresponding time period to include all candidate ROs of the set of candidate ROs in the corresponding time period; for the last time period, the BS may determine the set of ROs in the last time period to include first (K−(M−1)*N) candidate ROs in the set of candidate ROs, wherein M is the number of the at least one time period.

In another embodiment, in the case that K/M is a positive integer value, the set of ROs included in each time period may include a same number of ROs. For example, for each time period of the M time period, the BS may determine the set of ROs in a corresponding time period to include first (K/M) candidate ROs of the set of candidate ROs in the corresponding time period.

According to some embodiments of the present application, a total number of candidate ROs in each time period may be larger than or equal to the corresponding PRACH repetition number (i.e., N>=K). In such embodiments, the number of at least one time periods (i.e., M) is 1. That is, the at least one time period only includes one time period (i.e., M=1). In such embodiments, the BS may use the same methods as those used by the UE in the embodiments of FIG. 5 to determine the set of ROs in each time period.

In an embodiment, the BS may determine the set of ROs in the one time period to include first K candidate ROs of the set of candidate ROs in the one time period.

In another embodiment, the BS may divide first K*floor(N/K) candidate ROs in the set of candidate ROs in the one time period into floor(N/K) groups of candidate ROs; then the BS may determine the set of ROs in the one time period to include one group of candidate ROs within the floor(N/K) groups of candidate ROs.

In the above embodiments, the number of time periods for each PRACH repetition number may be determined based on the set of candidate ROs for a corresponding PRACH repetition number and the corresponding PRACH repetition number. However, according to some other embodiments of the present application, the number of time periods for PRACH repetition may not be determined based on the set of candidate ROs for each time period. In such embodiments, the configuration information in step 501 may further indicate a number of time periods associated with each PRACH repetition number of the set of PRACH repetition numbers. Accordingly, for each PRACH repetition number of the set of PRACH repetition numbers, the BS may determine a number of the at least one time periods to be the number of time periods indicated in the configuration information.

In such embodiments, the above methods for determining the position of the at least one time periods performed by the BS may also be applied herein.

According to some embodiments of the present application, the number of at least one time periods (i.e., M) associated with a corresponding PRACH repetition number (e.g., K) may be larger than 1. That is, the at least one time period includes more than one time period (i.e., M>1). In such embodiments, the BS may use the same methods as those used by the UE in the embodiments of FIG. 5 to determine the set of ROs in each time period.

In an embodiment, for each time period other than a last time period in the M time periods, the BS may determine the set of ROs in a corresponding time period to include first ceil(K/M) candidate ROs of a set of candidate ROs in the corresponding time period; for the last time period, the BS may determine that the set of ROs to include first (K−(M−1)*ceil(K/M)) candidate ROs of a set of candidate ROs in the last time period. In such embodiment, a set of candidate ROs may be determined based on the methods as stated above.

In another embodiment, in the case that K/M is a positive integer value, the set of ROs included in each time period includes a same number of ROs. For example, for each time period of the M time period, the BS may determine the set of ROs in a corresponding time period to include first (K/M) candidate ROs of the set of candidate ROs in the corresponding time period.

According to some other embodiments of the present application, the number of at least one time periods (i.e., M) associated with a corresponding PRACH repetition number (e.g., K) is one. That is, the at least one time period only includes more than one time period. In such embodiments, the above methods for determining the set of ROs in the one time period performed by the BS may also be applied herein.

FIG. 14 illustrates a simplified block diagram of an exemplary apparatus for beam pairing according to some embodiments of the present application. In some embodiments, the apparatus 1400 may be or include at least part of a UE (e.g., UE 102a or UE 102b in FIG. 1). In some other embodiments, the apparatus 1400 may be or include at least part of a BS (e.g., BS 101 in FIG. 1).

Referring to FIG. 14, the apparatus 1400 may include at least one transmitter 1402, at least one receiver 1404, and at least one processor 1406. The at least one transmitter 1402 is coupled to the at least one processor 1406, and the at least one receiver 1404 is coupled to the at least one processor 1406.

Although in this figure, elements such as the transmitter 1402, the receiver 1404, and the processor 1406 are illustrated in the singular, the plural is contemplated unless a limitation to the singular is explicitly stated. In some embodiments of the present application, the transmitter 1402 and the receiver 1404 may be combined to one device, such as a transceiver. In some embodiments of the present application, the apparatus 1400 may further include an input device, a memory, and/or other components. The transmitter 1402, the receiver 1404, and the processor 1406 may be configured to perform any of the methods described herein (e.g., the method described with respect to any of FIGS. 5-13).

According to some embodiments of the present application, the apparatus 1400 may be a UE, and the transmitter 1402, the receiver 1404, and the processor 1406 may be configured to perform operations of the any method as described with respect to FIGS. 5-12. For example, the receiver 1404 may be configured to receive configuration information indicating a set of PRACH repetition numbers. The processor 1406 may be configured to: select a PRACH repetition number from the set of PRACH repetition numbers; determine at least one time period for PRACH repetition based on the selected PRACH repetition number, wherein each time period of the at least one time period includes a set of ROs for PRACH repetition.

According to some embodiments of the present application, the apparatus 1400 may be a BS, and the transmitter 1402, the receiver 1404, and the processor 1406 may be configured to perform operations of the method as described with respect to FIG. 6-13. For example, the transmitter 1402 may be configured to transmit configuration information indicating a set of PRACH repetition numbers. The processor 1406 may be configured to for each PRACH repetition number in the set of PRACH repetition numbers, determine at least one time period for PRACH repetition based on a corresponding PRACH repetition number, wherein each time period of the at least one time period includes a set of ROs for PRACH repetition.

In some embodiments of the present application, the apparatus 1400 may further include at least one non-transitory computer-readable medium. In some embodiments of the present disclosure, the non-transitory computer-readable medium may have stored thereon computer-executable instructions to cause the processor 1406 to implement any of the methods as described above. For example, the computer-executable instructions, when executed, may cause the processor 1406 to interact with the transmitter 1402 and/or the receiver 1404, so as to perform operations of the methods, e.g., as described with respect to FIGS. 5-13.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for PRACH repetition, including a processor and a memory. Computer programmable instructions for implementing a method for PRACH repetition are stored in the memory, and the processor is configured to perform the computer programmable instructions to implement the method for PRACH repetition. The method for PRACH repetition may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for PRACH repetition according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE), comprising:
at least one memory; and
at least one processor coupled with the at least one memory and configured to cause the UE to:
obtain configuration information indicating a set of physical random access channel (PRACH) repetition numbers;
select a PRACH repetition number from the set of PRACH repetition numbers; and
determine at least one time period for PRACH repetition based on the selected PRACH repetition number, wherein each time period of the at least one time period includes a set of random access channel (RACH) occasions (ROs) for PRACH repetition.

2. The UE of claim 1, wherein the at least one processor is configured to cause the UE to:
determine a set of candidate ROs that are associated with a same synchronization signal and physical broadcast channel (PBCH) block (SSB) for each time period;
wherein the set of ROs for PRACH repetition in each time period is the same as the set of candidate ROs, or is a subset of the set of candidate ROs.

3. The UE of claim 1, wherein the set of ROs for PRACH repetition are not frequency domain multiplexed (FDMed) in a same time occasion.

4. The UE of claim 1, wherein each time period is at least one SSB to RO association period.

5. The UE of claim 2, wherein the at least one processor is configured to cause the UE to index FDMed RO(s) associated with the same SSB in each time period according to a pre-defined order, wherein the set of candidate ROs includes RO(s) with a same index in each time period.

6. The UE of claim 5, wherein the indexing of FDMed RO(s) starts from low to high in frequency.

7. The UE of claim 2, wherein the at least one processor is configured to cause the UE to receive at least one of:
first configuration information indicating a set of available SSBs; or
second configuration information indicating a subset of the set of available SSBs;
wherein the same SSB is determined from the set of available SSBs or the subset.

8. The UE of claim 2, wherein the at least one processor is configured to cause the UE to determine a number of the at least one time period to be ceil(K/N), wherein K is the selected PRACH repetition number and N is a number of candidate ROs in the set of candidate ROs.

9. The UE of claim 8, wherein in response to a total number of candidate ROs in each time period being smaller than the selected PRACH repetition number, the at least one processor is configured to cause the UE to:
for each time period other than a last time period in the at least one time period, determine the set of ROs in a corresponding time period to include all candidate ROs of the set of candidate ROs in the corresponding time period; and
for the last time period, determine the set of ROs in the last time period to include first (K−(M−1)*N) candidate ROs in the set of candidate ROs, wherein M is the number of the at least one time period.

10. The UE of claim 1, wherein the configuration information further indicates a number of time periods associated with each PRACH repetition number of the set of PRACH repetition numbers, and wherein the at least one processor is configured to cause the UE to determine a number of the at least one time period for the selected PRACH repetition number based on the configuration information.

11. The UE of claim 1, wherein the set of ROs included in each time period includes a same number of ROs.

12. The UE of claim 1, wherein the at least one processor is configured to cause the UE to index time periods starting from a reference point, wherein the at least one time period is started from a time period with an index n, wherein n/M is an integer value and M is a number of the at least one time period.

13. The UE of claim 1, wherein the at least one processor is configured to cause the UE to:
divide time periods starting from a reference point into one or more groups, each group includes M consecutive time periods, wherein M is a number of the at least one time period; and
index the one or more groups, wherein at least one time period is in a group of the one or more groups.

14. A base station (BS), comprising:
at least one memory; and
at least one processor coupled with the at least one memory and configured to cause the base station to:
transmit configuration information indicating a set of physical random access channel (PRACH) repetition numbers; or
obtain the configuration information; and
for each PRACH repetition number in the set of PRACH repetition numbers, determine at least one time period for PRACH repetition based on a corresponding PRACH repetition number, wherein each time period of the at least one time period includes a set of random access channel (RACH) occasions (ROs) for PRACH repetition.

15. A method performed by a user equipment (UE), the method comprising:
obtaining configuration information indicating a set of physical random access channel (PRACH) repetition numbers;
determining a PRACH repetition number from the set of PRACH repetition numbers; and
determining at least one time period for PRACH repetition based on the determined PRACH repetition number, wherein each time period of the at least one time period includes a set of random access channel (RACH) occasions (ROs) for PRACH repetition.

16. A processor for wireless communication, comprising:
at least one controller coupled with at least one memory and configured to cause the processor to:
obtain configuration information indicating a set of physical random access channel (PRACH) repetition numbers;
select a PRACH repetition number from the set of PRACH repetition numbers; and
determine at least one time period for PRACH repetition based on the selected PRACH repetition number, wherein each time period of the at least one time period includes a set of random access channel (RACH) occasions (ROs) for PRACH repetition.

17. The processor of claim 16, wherein the at least one controller is configured to cause the processor to:
determine a set of candidate ROs that are associated with a same synchronization signal and physical broadcast channel (PBCH) block (SSB) for each time period;
wherein the set of ROs for PRACH repetition in each time period is the same as the set of candidate ROs, or is a subset of the set of candidate ROs.

18. The processor of claim 16, wherein the set of ROs for PRACH repetition are not frequency domain multiplexed (FDMed) in a same time occasion.

19. The processor of claim 16, wherein each time period is at least one SSB to RO association period.

20. The processor of claim 17, wherein the at least one controller is configured to cause the processor to index FDMed RO(s) associated with the same SSB in each time period according to a pre-defined order, wherein the set of candidate ROs includes RO(s) with a same index in each time period.
